(19) United States
(12) Patent Application Publication
(10) Pub. No.: US 2021/0108462 A1
(43) Pub. Date: Apr. 15, 2021

(54) CONTROL SYSTEM FOR NON-LIGHT-EMITTING VARIABLE TRANSMISSION DEVICES AND A METHOD OF USING THE SAME

(71) Applicant: SAGE ELECTROCHROMICS, INC., Faribault, MN (US)

(72) Inventors: Ahoo MALEKAFZALI ARDAKAN, Cottonwood Heights, UT (US); Yigang WANG, Plymouth, MN (US)

(21) Appl. No.: 17/069,972

(22) Filed: Oct. 14, 2020

Related U.S. Application Data
(60) Provisional application No. 62/915,353, filed on Oct. 15, 2019.

(51) Int. Cl. E06B 9/24; G06K 9/00; G05B 19/418

(52) U.S. Cl. CPC E06B 9/24; G06K 9/00691; G05B 2219/2642; E06B 2009/2464; G05B 19/4183

(57) ABSTRACT

A system can include a system that includes a control device configured to select a first scene from a collection of scenes for a window including switchable devices in response to receiving a first input corresponding to prioritized state information, and a remote management system configured to send the prioritized state information.

### CROSS-REFERENCE TO RELATED APPLICATION(S)

This application claims priority under 35 U.S.C § 119(e) to U.S. Provisional Application No. 62/915,353, entitled “CONTROL SYSTEM FOR NON-LIGHT-EMITTING VARIABLE TRANSMISSION DEVICES AND A METHOD OF USING THE SAME,” by Ahoo MALEKAFZALI ARDAKAN et al., filed Oct. 15, 2019, which is assigned to the current assignee hereof and is incorporated herein by reference in its entirety.

### FIELD OF THE DISCLOSURE

The present disclosure is directed to systems that include non-light-emitting variable transmission devices, and more specifically to systems including routers, controllers and non-light-emitting variable transmission devices and methods of using the same.

### BACKGROUND

A non-light-emitting variable transmission device can reduce glare and the amount of sunlight entering a room. Buildings can include many non-light-emitting variable transmission devices that may be controlled locally (at each individual or a relatively small set of devices), for a room, or for a building (a relatively large set of devices). Wiring the devices can be very time consuming and complicated, particularly as the number of devices being controlled increases. Connecting the devices to their corresponding control system can be performed on a wire-by-wire basis using electrical connectors or connecting techniques, such as terminal strips, splicing, soldering, wire nuts, or the like. Tracking down wiring issues can be difficult, particularly, as the number of devices increase and the length of the wiring becomes longer. Replacement of control equipment can become a very difficult task. A need exists for a better control strategy.

### BRIEF DESCRIPTION OF THE DRAWINGS

Embodiments are illustrated by way of example and are not limited in the accompanying figures.

FIG. 1 includes a schematic depiction of a system for controlling a set of non-light-emitting, variable transmission devices in accordance with an embodiment.

FIG. 2 includes an illustration of a top view of the substrate, the stack of layers, and the bus bars.

FIG. 3A includes an illustration of a cross-sectional view along line A of a portion of a substrate, a stack of layers for an electrochromic device, and bus bars, according to one embodiment.

FIG. 3B includes an illustration of a cross-sectional view along line B of a portion of a substrate, a stack of layers for an electrochromic device, and bus bars, according to one embodiment.

FIG. 4 includes a flow diagram for operating the system of FIG. 1 or 2.

FIGS. 5A-5L include an illustration of a facade.

Skilled artisans appreciate that elements in the figures are illustrated for simplicity and clarity and have not necessarily been drawn to scale. For example, the dimensions of some of the elements in the figures may be exaggerated relative to other elements to help to improve understanding of embodiments of the invention.

### DETAILED DESCRIPTION

The following description in combination with the figures is provided to assist in understanding the teachings disclosed herein. The following discussion will focus on specific implementations and embodiments of the teachings. This focus is provided to assist in describing the teachings and should not be interpreted as a limitation on the scope or applicability of the teachings.

The terms “normal operation” and “normal operating state” refer to conditions under which an electrical component or device is designed to operate. The conditions may be obtained from a data sheet or other information regarding voltages, currents, capacitances, resistances, or other electrical parameters. Thus, normal operation does not include operating an electrical component or device well beyond its design limits.

The term “color rendering”, when referring to an electrical device, is intended to refer to the amount of light transmission permitted through an electrochromic window for a space to keep the color within the space within a wavelength of between 680 nm and 720 nm.

As used herein, the terms “comprises,” “comprising,” “includes,” “including,” “has,” “having,” or any other variation thereof, are intended to cover a non-exclusive inclusion. For example, a process, method, article, or apparatus that comprises a list of features is not necessarily limited only to those features but may include other features not expressly listed or inherent to such process, method, article, or apparatus. Further, unless expressly stated to the contrary, “or” refers to an inclusive-or and not to an exclusive-or. For example, a condition A or B is satisfied by any one of the following: A is true (or present) and B is false (or not present), A is false (or not present) and B is true (or present), and both A and B are true (or present).

The use of “a” or “an” is employed to describe elements and components described herein. This is done merely for convenience and to give a general sense of the scope of the invention. This description should be read to include one or at least one and the singular also includes the plural, or vice versa, unless it is clear that it is meant otherwise.

The use of the word “about,” “approximately,” or “substantially” is intended to mean that a value of a parameter is close to a stated value or position. However, minor differences may prevent the values or positions from being exactly as stated. Thus, differences of up to ten percent (10%) for the value are reasonable differences from the ideal goal of exactly as described.

Unless otherwise defined, all technical and scientific terms used herein have the same meaning as commonly understood by one of ordinary skill in the art to which this invention belongs. The materials, methods, and examples are illustrative only and not intended to be limiting. To the extent not described herein, many details regarding specific materials and processing acts are conventional and may be found in textbooks and other sources within the glass, vapor deposition, and electrochromic arts.

A system can include a non-light-emitting, variable transmission device; a controller coupled and configured to provide power to the non-light-emitting, variable transmission device; and a router configured to provide power and control signals to the controller.

The systems and methods are better understood after reading the specification in conjunction with the figures. System architectures are described and illustrated, followed by an exemplary construction of a non-light-emitting, variable transmission device, and a method of controlling the system. The embodiments described are illustrative and not meant to limit the scope of the present invention, as defined by the appended claims.

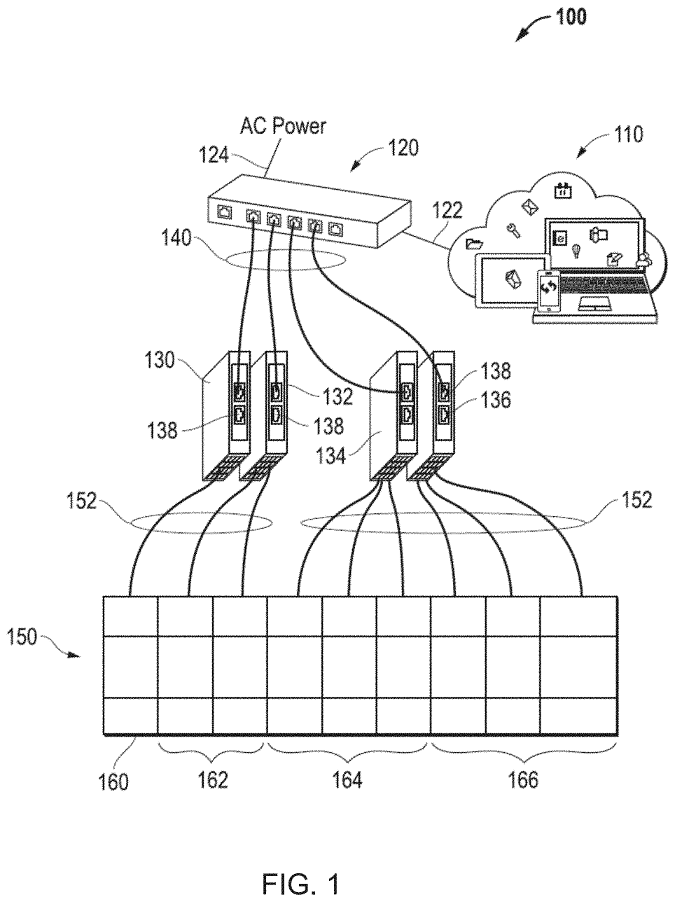

Referring to FIG. 1, a system for controlling a set of non-light-emitting, variable transmission devices is illustrated and is generally designated 100. As depicted, the system 100 can include a building management system 110. In a particular aspect, the building management system 110 can include a computing device such as a desk top computer, a laptop computer, a tablet computer, a smartphone, some other computing device, or a combination thereof. The building management system 110 can be used to control the heating ventilation air condition (HVAC) system of the building, interior lighting, exterior lighting, emergency lighting, fire suppression equipment, elevators, escalators, alarms, security cameras, access doors, another suitable component or sub-system of the building, or any combination thereof.

As illustrated in FIG. 1, the system 100 can include a router 120 connected to the building management system 110 via a control link 122. The control link 122 can be a wireless connection. In an embodiment, the control link 122 can use a wireless local area network connection operating according to one or more of the standards within the IEEE 802.11 (WiFi) family of standards. In a particular aspect, the wireless connections can operate within the 2.4 GHz ISM radio band, within the 5.0 GHz ISM radio band, or a combination thereof.

Regardless of the type of control link 122, the building management system 110 can provide control signals to the router 120 via the control link 122. The control signals can be used to control the operation of one or more non-light-emitting variable transmission devices that are indirectly, or directly, connected to the router 120 and described in detail below. As indicated in FIG. 1, the router 120 can be connected to an alternating current (AC) power source 124. The router 120 can include an onboard AC-to-direct current (DC) converter (not illustrated). The onboard AC-to-DC converter can convert the incoming AC power from the AC power source 124, approximately 120 Volts (V) AC, to a DC voltage that is at most 60 VDC, 54 VDC, 48 VDC, 24 VDC, at most 12 VDC, at most 6 VDC, or at most 3 VDC.

FIG. 1 also indicates that the router 120 can include a plurality of connectors. In a particular aspect, the connectors 126 can include one or more RJ-11 jacks, one or more RJ-14 jacks, one or more RJ-25 jacks, one or more RJ-45 jacks, one or more 8P8C jacks, another suitable jack, or a combination thereof. In another aspect, the connectors 126 can include one or more universal serial bus (USB) jacks. In a particular embodiment, the connectors 126 can be USB-C connectors.

As further illustrated in FIG. 1, the system 100 can include controllers 130, 132, 134, and 136 connected to the router 120. The router 120 can be configured to provide power and control signals to the controllers 130, 132, 134, and 136. In a particular aspect, the router 120 can include a power inlet port and a control signal port. The router 120 can be configured to receive power via and power inlet port 124 and provide power to any or all of the controllers 130, 132, 134, and 136 and receive control signals via a control link and provide control signals to any or all of the controllers 130, 132, 134, and 136. The onboard AC-to-DC converter within the router 120 can be coupled to the power input port of the router 120. The router 120 can further include a component that is configured to reduce a voltage of power received over the power input port to voltages of power transmitted over the controller port. The component can include a transformer or a voltage regulator.

Each of the controllers 130, 132, 134, and 136 can include a plurality of connectors 138. The connectors 138 on the controllers 130, 132, 134, and 136 can include one or more RJ-11 jacks, one or more RJ-14 jacks, one or more RJ-25 jacks, one or more RJ-45 jacks, one or more 8P8C jacks, another suitable jack, or a combination thereof. In another aspect, the connectors 138 can include one or more USB jacks. In a particular embodiment, the connectors 138 can be USB-C connectors. In still another aspect, the connectors on the controllers 130, 132, 134, and 136 can be substantially identical to the connectors 126 of the router 120.

As illustrated in FIG. 1, a plurality of cables 140 can used to connect the controllers 130, 132, 134, and 136 to the router 120. Each of the cables 140 can include a Category 3 cable, a Category 5 cable, a Category 5e cable, a Category 6 cable, or another suitable cable. In an embodiment, the plurality of cables 140 can include twisted pair conductors, such as twisted pair wires. In another embodiment, each cable 140 can be configured to transmit at least 4 W of power, and in another embodiment, each cable can be configured to transmit at most 200 W of power. In another embodiment, each cable 140 can be configured to support a data rate of at least 3 Mb/s, and in another embodiment, each cable can be configured to support a data rate of at most 100 Gb/s. Each of the cables 140 can include a male connector crimped on, or otherwise affixed to, the distal and proximal ends of each of the cables 140. In addition, each male connector can include an RJ-11 plug, an RJ-14 plug, an RJ-25 plug, an RJ-45 plug, an 8P8C plug, another suitable plug, or a combination thereof. In another aspect, the male connectors can include one or more USB plugs. In a particular embodiment, the male connectors can be USB-C connectors. In an embodiment, the male and female connectors at each connection can be complementary connectors. While the system 100 of FIG. 1 is illustrated with four controllers 130, 132, 134, and 136, the system 100 may include more or fewer controllers.

Still referring to FIG. 1, the system 100 can also include a window frame panel 150 electrically connected to the controllers 130, 132, 134, and 136 via a plurality of sets of frame cables 152. The window frame panel 150 can include a plurality of non-light-emitting, variable transmission devices, each of which may be connected to its corresponding controller via its own frame cable. In the embodiment as illustrated, the non-light-emitting, variable transmission devices are oriented in a 3×9 matrix. In another embodiment, a different number of non-light-emitting, variable transmission devices, a different matrix of the non-light-emitting, variable transmission devices, or both may be used. Each of the non-light-emitting, variable transmission devices may be on separate glazings. In another embodiment, a plurality of non-light-emitting, variable transmission devices can share a glazing. For example, a glazing may correspond to a column of non-light-emitting, variable transmission devices in FIG. 1. A glazing may correspond to a plurality of column of non-light-emitting, variable transmission devices. In another embodiment, a pair of glazings in the window frame panel 150 can have different sizes, such glazings can have a different numbers of non-light-emitting, variable transmission devices. After reading this specification, skilled artisans will be able to determine a particular number and organization of non-light-emitting, variable transmission devices for a particular application.

In a particular, non-limiting embodiment, the window frame panel 150 can include a set 160 of non-light-emitting, variable transmission devices coupled to the controller 130 via a set of frame cables 152. The window frame panel 150 can also include a set 162 of non-light-emitting, variable transmission devices connected to the controller 132 via sets of frame cables 152. Moreover, the window frame panel 150 can include a set 164 of non-light-emitting, variable transmission devices connected to the controller 134 via other sets frame cables 152, and a set 166 of non-light-emitting, variable transmission devices connected to the controller 136 via further sets frame cables 152. While the system 100 of FIG. 1 is illustrated with the sets 160, 162, 164, and 166, the system 100 may include more or fewer sets of non-light-emitting, variable transmission devices.

The controllers 130, 132, 134, and 136 can provide power to the sets 160, 162, 164, and 166 of non-light-emitting, variable transmission devices connected thereto via the sets of frame cables 152. The power provided to the sets 160, 162, 164, and 166 can have a voltage that is at most 12 V, at most 6 V, or at most 3 V. The controllers 130, 132, 134, and 136 can be used to control operation of the non-light-emitting, variable transmission devices within the sets 160, 162, 164, and 166. During operation, the non-light-emitting, variable transmission devices within the sets 160, 162, 164, and 166 act similar to capacitors. Thus, most of the power is consumed when the non-light-emitting, variable transmission devices are in their switching states, not in their static states. In one example, the router 120 may have a power rating of 500 W, and each of the controllers 130, 132, 134, and 136 can have a power rating of 80 W. However, the number of controllers, with power ratings of 80 W each, may exceed the router's power rating of 500 W.

In order to manage this power scheme, the system 100 can utilize the power ratings of the non-light-emitting, variable transmission devices for the sets 160, 162, 164, and 166 and allocate the power to these devices based on what the controllers 130, 132, 134, and 136 will need in order to provide full power to all non-light-emitting, variable transmission devices coupled to the router 120 via the controllers 130, 132, 134, and 136. The power ratings of the non-light-emitting, variable transmission devices of the sets 160, 162, 164, and 166 can be obtained from information that exists in conjunction with the non-light-emitting, variable transmission devices of the sets 160, 162, 164, and 166. For example, this information may be contained within an identification (ID) tag on each non-light-emitting, variable transmission device, within a look-up table provided in conjunction with these devices, information provided by the building management system 110, or an external source. Alternatively, this information can be obtained by an analog method, e.g., a resistance associated with each of these devices.

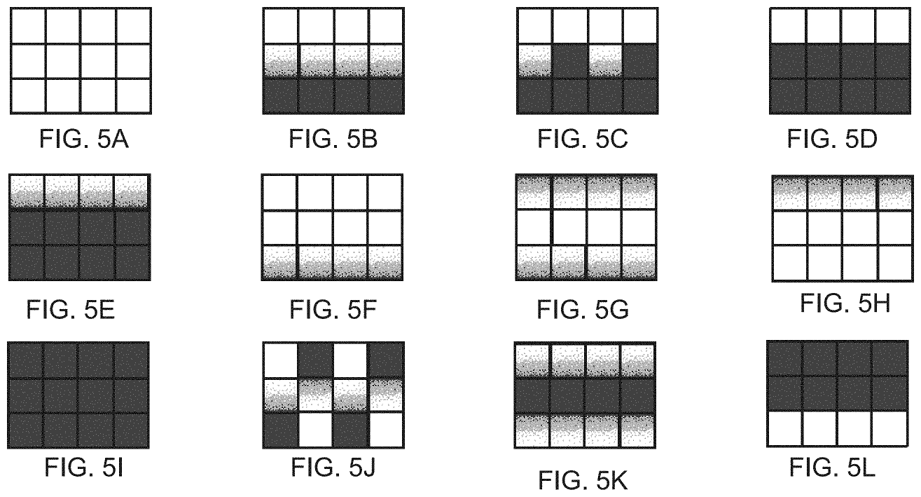

The allocation of power to the controllers 130, 132, 134, and 136 can be performed as part of a start-up routine after initial configuring or reconfiguring the system 100 or during a reboot of the system 100. The method of operation is described in greater detail below in conjunction with FIG. 5. With respect to a configuration, the system 100 can include a logic element, e.g., within the router 120 that can perform the method steps described below. In particular, the logic element can be configured to determine power requirements for the controllers coupled to the router and allocate power to the controllers corresponding to the power requirements. The power requirements for the controllers 130, 132, 134, and 136 can be obtained by determining the power ratings of the non-light-emitting, variable transmission devices coupled to each of the controllers 130, 132, 134, and 136 and the associated connectors and wiring (e.g., sets of frame cables 152) between the controllers 130, 132, 134, and 136 and their corresponding non-light-emitting, variable transmission devices. Each of the controllers and the router can have a power rating and a sum of the power ratings of the controllers can be greater than the power rating of the router. The system 100 can be configured such that all of the non-light-emitting, variable transmission devices coupled to the controllers can receive full power simultaneously. Moreover, at least two of the controllers 130, 132, 134, and 136 can have different power requirements and different power allocations. Further, at least two of the controllers 130, 132, 134, and 136 can have a same power rating.

In another aspect, for each of the controllers 130, 132, 134, and 136, the power requirement is a sum of power ratings of the non-light-emitting, variable transmission devices within the sets 160, 162, 164, 166. Within the system 100, the power and the control signals for each of the controllers 130, 132, 134, and 136 can be configured to be transmitted over different conductors within the first cable. Specifically, the system 100 can be configured such that the power is transmitted over a first twisted pair of conductors of a cable, and the control signals are transmitted over a second twisted pair of conductors of the same cable. Alternatively, the system 100 can also be configured such that at least part of the power and at least part of the control signals for a controller are transmitted over a same conductor of a cable.

The system can be used with a wide variety of different types of non-light-emitting variable transmission devices. The apparatuses and methods can be implemented with switchable devices that affect the transmission of light through a window. Much of the description below addresses embodiments in which the switchable devices are electrochromic devices. In other embodiments, the switchable devices can include suspended particle devices, liquid crystal devices that can include dichroic dye technology, and the like. Thus, the concepts as described herein can be extended to a variety of switchable devices used with windows.

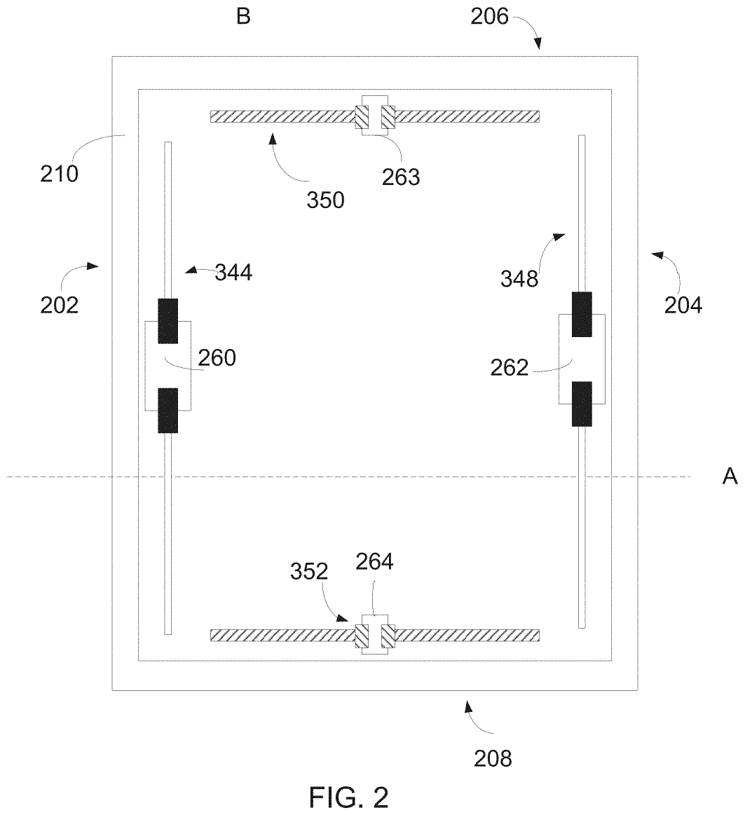

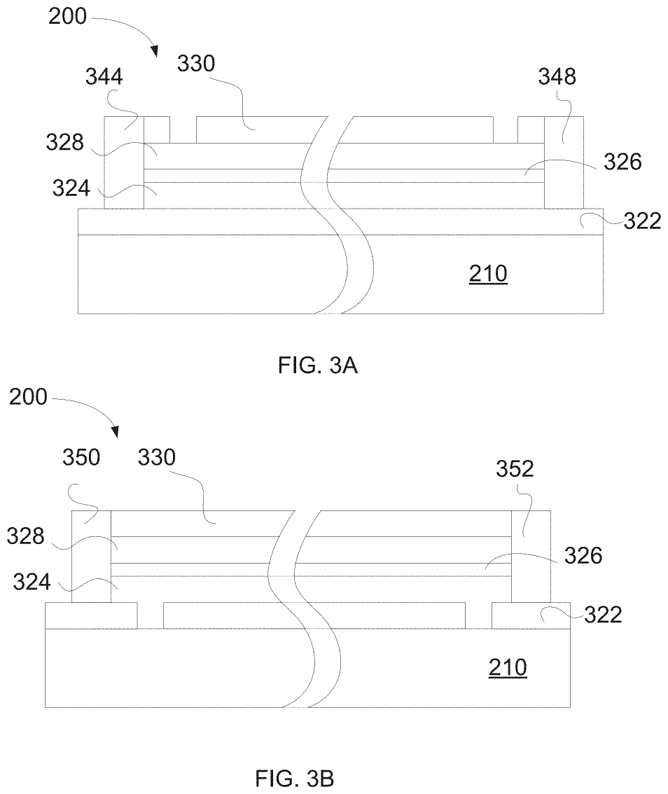

The description with respect to FIGS. 2, 3A, and 3B provide exemplary embodiments of a glazing that includes a glass substrate and a non-light-emitting variable transmission device disposed thereon. The embodiment as described with respect to 2, 3A, and 3B is not meant to limit the scope of the concepts as described herein. In the description below, a non-light-emitting variable transmission device will be described as operating with voltages on bus bars being in a range of 0 V to 3 V. Such description is used to simplify concepts as described herein. Other voltage may be used with the non-light-emitting variable transmission device or if the composition or thicknesses of layers within an electrochromic stack are changed. The voltages on bus bars may both be positive (1 V to 4 V), both negative (−5 V to −2 V), or a combination of negative and positive voltages (−1 V to 2 V), as the voltage difference between bus bars are more important than the actual voltages. Furthermore, the voltage difference between the bus bars may be less than or greater than 3 V. After reading this specification, skilled artisans will be able to determine voltage differences for different operating modes to meet the needs or desires for a particular application. The embodiments are exemplary and not intended to limit the scope of the appended claims.

FIG. 2 an illustration of a top view of a substrate 200, a stack of layers of an electrochromic device 322, 324, 326, 328, and 330, and bus bars 344, 348, 350, and 352 overlying the substrate 300, according to one embodiment. In an embodiment, the substrate 210 can include a glass substrate, a sapphire substrate, an aluminum oxynitride substrate, or a spinel substrate. In another embodiment, the substrate 210 can include a transparent polymer, such as a polyacrylic compound, a polyalkene, a polycarbonate, a polyester, a polyether, a polyethylene, a polyimide, a polysulfone, a polysulfide, a polyurethane, a polyvinylacetate, another suitable transparent polymer, or a co-polymer of the foregoing. The substrate 210 may or may not be flexible. In a particular embodiment, the substrate 210 can be float glass or a borosilicate glass and have a thickness in a range of 0.5 mm to 4 mm thick. In another particular embodiment, the substrate 210 can include ultra-thin glass that is a mineral glass having a thickness in a range of 50 microns to 300 microns. In a particular embodiment, the substrate 210 may be used for many different non-light-emitting variable transmission devices being formed and may referred to as a motherboard.

The bus bar 344 lies along a side 202 of the substrate 210 and the bus bar 348 lies along a side 204 that is opposite the side 202. The bus bar 350 lies along side 206 of the substrate 210, and the bus bar 352 lies along side 208 that is opposite side 206. Each of the bus bars 344, 348, 350, and 352 have lengths that extend a majority of the distance each side of the substrate. In a particular embodiment, each of the bus bars 344, 348, 350, and 352 have a length that is at least 75%, at least 90%, or at least 95% of the distance between the sides 202, 204, 206, and 208 respectively. The lengths of the bus bars 344 and 348 are substantially parallel to each other. As used herein, substantially parallel is intended to means that the lengths of the bus bars 344 and 348, 350 and 352 are within 10 degrees of being parallel to each other. Along the length, each of the bus bars has a substantially uniform cross-sectional area and composition. Thus, in such an embodiment, the bus bars 344, 348, 350, and 352 have a substantially constant resistance per unit length along their respective lengths.

In one embodiment, the bus bar 344 can be connected to a first voltage supply terminal 260, the bus bar 348 can be connected to a second voltage supply terminal 262, the bus bar 350 can be connected to a third voltage supply terminal 263, and the bus bar 352 can be connected to a fourth voltage supply terminal 264. In one embodiment, the voltage supply terminals can be connected to each bus bar 344, 348, 350, and 352 about the center of each bus bar. In one embodiment, each bus bar 344, 348, 350, and 352 can have one voltage supply terminal. The ability to control each voltage supply terminal 260, 262, 263, and 264 provide for control over grading of light transmission through the electrochromic device 124.

In one embodiment, the first voltage supply terminal 260 can set the voltage for the bus bar 344 at a value less than the voltage set by the voltage supply terminal 263 for the bus bar 350. In another embodiment, the voltage supply terminal 263 can set the voltage for the bus bar 350 at a value greater than the voltage set by the voltage supply terminal 264 for the bus bar 352. In another embodiment, the voltage supply terminal 263 can set the voltage for the bus bar 350 at a value less than the voltage set by the voltage supply terminal 264 for the fourth bus bar 352. In another embodiment, the voltage supply terminal 260 can set the voltage for the bus bar 344 at a value about equal to the voltage set by the voltage supply terminal 262 for the bus bar 348. In one embodiment, the voltage supply terminal 260 can set the voltage for the bus bar 344 at a value within about 0.5 V, such as 0.4 V, such as 0.3 V, such as 0.2 V, such as 0.1 V to the voltage set by the voltage supply terminal 262 for the second bus bar 348. In a non-limiting example, the first voltage supply terminal 260 can set the voltage for the bus bar 344 at 0 V, the second voltage supply terminal 262 can set the voltage for the bus bar 348 at 0 V, the third voltage supply terminal 263 can set the voltage for the bus bar 350 at 3 V, and the fourth voltage supply terminal 264 can set the voltage for the bus bar 352 at 1.5 V.

The compositions and thicknesses of the layers are described with respect to FIGS. 3A and 3B. Transparent conductive layers 322 and 330 can include a conductive metal oxide or a conductive polymer. Examples can include a tin oxide or a zinc oxide, either of which can be doped with a trivalent element, such as Al, Ga, In, or the like, a fluorinated tin oxide, or a sulfonated polymer, such as polyaniline, polypyrrole, poly(3,4-ethylenedioxythiophene), or the like. In another embodiment, the transparent conductive layers 322 and 330 can include gold, silver, copper, nickel, aluminum, or any combination thereof. The transparent conductive layers 322 and 330 can have the same or different compositions.

The set of layers further includes an electrochromic stack that includes the layers 324, 326, and 328 that are disposed between the transparent conductive layers 322 and 330. The layers 324 and 328 are electrode layers, wherein one of the layers is an electrochromic layer, and the other of the layers is an ion storage layer (also referred to as a counter electrode layer). The electrochromic layer can include an inorganic metal oxide electrochemically active material, such as WO₃, V₂O₅, MoO₃, Nb₂O₅, TiO₂, CuO, Ir₂O₃, Cr₂O₃, CO₂O₃, Mn₂O₃, or any combination thereof and have a thickness in a range of 50 nm to 2000 nm. The ion storage layer can include any of the materials listed with respect to the electrochromic layer or Ta₂O₅, Zr₂, HfO₂, Sb₂O₃, or any combination thereof, and may further include nickel oxide (NiO, Ni₂O₃, or combination of the two), and Li, Na, H, or another ion and have a thickness in a range of 80 nm to 500 nm. An ion conductive layer 326 (also referred to as an electrolyte layer) is disposed between the electrode layers 324 and 328, and has a thickness in a range of 20 microns to 60 microns. The ion conductive layer 326 allows ions to migrate therethrough and does not allow a significant number of electrons to pass therethrough. The ion conductive layer 326 can include a silicate with or without lithium, aluminum, zirconium, phosphorus, boron; a borate with or without lithium; a tantalum oxide with or without lithium; a lanthanide-based material with or without lithium; another lithium-based ceramic material; or the like. The ion conductive layer 326 is optional and, when present, may be formed by deposition or, after depositing the other layers, reacting portions of two different layers, such as the electrode layers 324 and 328, to form the ion conductive layer 326. After reading this specification, skilled artisans will appreciate that other compositions and thicknesses for the layers 322, 324, 326, 328, and 330 can be used without departing from the scope of the concepts described herein.

The layers 322, 324, 326, 328, and 330 can be formed over the substrate 210 with or without any intervening patterning steps, breaking vacuum, or exposing an intermediate layer to air before all the layers are formed. In an embodiment, the layers 322, 324, 326, 328, and 330 can be serially deposited. The layers 322, 324, 326, 328, and 330 may be formed using physical vapor deposition or chemical vapor deposition. In a particular embodiment, the layers 322, 324, 326, 328, and 330 are sputter deposited.

In the embodiment illustrated in FIGS. 3A and 3B, each of the transparent conductive layers 322 and 330 include portions removed, so that the bus bars 344/348 and 350/352 a are not electrically connected to each other. Such removed portions are typically 20 nm to 2000 nm wide. In a particular embodiment, the bus bars 344 and 348 are electrically connected to the electrode layer 324 via the transparent conductive layer 322, and the bus bars 350 and 352 are electrically connected to the electrode layer 328 via the transparent conductive layer 330. The bus bars 344, 348, 350, and 352 include a conductive material. In an embodiment, each of the bus bars 344, 348, 350, and 352 can be formed using a conductive ink, such as a silver frit, that is printed over the transparent conductive layer 322. In another embodiment, one or both of the bus bars 344, 348, 350, and 352 can include a metal-filled polymer. In a particular embodiment (not illustrated), the bus bars 350 and 352 are each a non-penetrating bus bar that can include the metal-filled polymer that is over the transparent conductive layer 330 and spaced apart from the layers 322, 324, 326, and 328. The viscosity of the precursor for the metal-filled polymer may be sufficiently high enough to keep the precursor from flowing through cracks or other microscopic defects in the underlying layers that might be otherwise problematic for the conductive ink. The lower transparent conductive layer 322 does not need to be patterned in this particular embodiment. In one embodiment, bus bars 344 and 348 are opposed each other. In one embodiment, bus bars 350 and 352 are orthogonal to bus bar 344.

In the embodiment illustrated, the width of the non-light-emitting variable transmission device WEC is a dimension that corresponds to the lateral distance between the removed portions of the transparent conductive layers 322 and 330. WS is the width of the stack between the bus bars 344 and 348. The difference in WS and WEC is at most 5 cm, at most 2 cm, or at most 0.9 cm. Thus, most of the width of the stack corresponds to the operational part of the non-light-emitting variable transmission device that allows for different transmission states. In an embodiment, such operational part is the main body of the non-light-emitting variable transmission device and can occupy at least 90%, at least 95%, at least 98% or more of the area between the bus bars 344 and 348.

Attention is now addressed to installing, configuring, and using the system as illustrated in FIG. 1 with glazings and non-light-emitting, variable transmission devices that can be similar to the glazing and non-light-emitting, variable transmission device as illustrated and described with respect to FIGS. 2, 3A and 3B. In another embodiment, other designs of glazings and non-light-emitting, variable transmission devices.

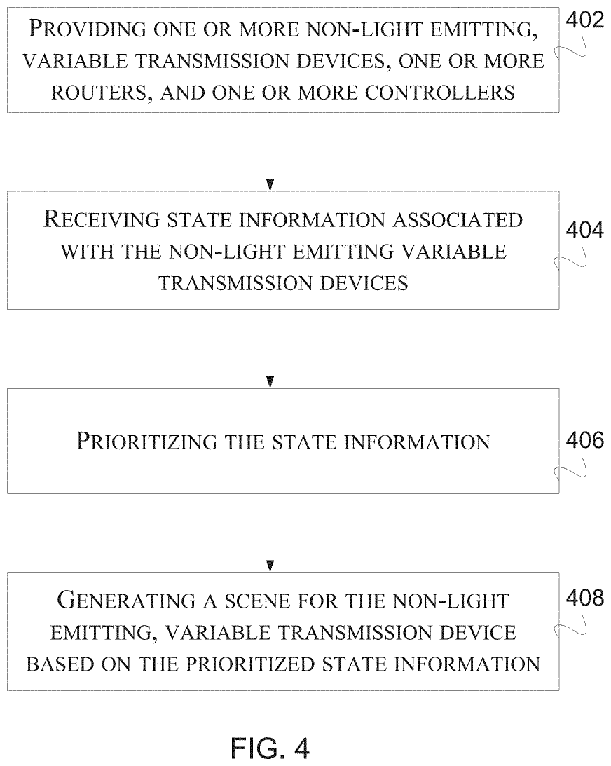

FIG. 4 includes flow chart for a method 400 of operating the system 100 illustrated in FIG. 1. Commencing at block 402, the method can include providing one or more non-light-emitting, variable transmission devices, one or more routers, and one or more controllers coupled to the one or more glazings and the one or more routers. In an embodiment, the non-light-emitting, variable transmission devices, routers, and controllers may be connected to each other as illustrated in FIG. 1 and use non-light-emitting variable transmission devices similar to the non-light-emitting variable transmission device described and illustrated in FIGS. 2, 3A, and 3B.

The building management system 110 can include logic to control the operation of building environmental and facility controls, such as heating, ventilation, and air conditioning (HVAC), lights, scenes for EC devices, including the EC device 200. The logic for the building management systems 110 can be in the form of hardware, software, or firmware. In an embodiment, the logic may be stored in a field programmable gate array (FPGA), an application-specific integrated circuit (ASIC), a hard drive, a solid state drive, or another persistent memory. In an embodiment, the building management system 110 may include a processor that can execute instructions stored in memory within the building management system 110 or received from an external source. In one embodiment, the external source can include a rooftop device. The device can be mounted on the roof of a building that contains the non-light emitting, variable transmission devices. In one embodiment the external source can be one or more devices that include 360 degree sensors. In another embodiment the external source can be one or more devices that include 180 degree sensors. The device can include an outer covering and one or more sensors. Each sensor can be spaced around a central axis and point in a different direction. Each sensor can be spaced apart by between 5 and 25 degrees. The one or more sensors can be oriented around the central point such that sensors surround the central point by 360 degrees. Each sensor can have a range from 45 to 180 degrees. In one embodiment, the device can include at least 4 sensors, such as at least 5 sensors, at least 7 sensors, at least 10 sensors. In one embodiment, the device can include no more than 30 sensors. Each sensor can return measurements on LUX, temperature, irradiance, direction, levels of light, weather measurements, and more. The device can include a compass to orient the one or more sensors. In one embodiment, the sensor can be powered by either 24 VA or power over Ethernet (POE). By combining the data from the plurality of sensors, the device can receive data from a 360 degree field of view. In one embodiment, data from a single sensor can be taken. As such, the device can receive data from between a 5 degree and 360 degree field of view based from a central point of the device. Each sensor can include one or more filters and may or may not be visible through the outer covering.

Continuing the description of the method 400, at block 404, the method can include receiving state information associated with the non-light emitting, variable transmission devices of the glazing. The collection of state information may occur nearly continuously, such as from a motion sensor, light sensor, or the like, on a periodic basis, such as once a minute, every ten minutes, hourly, or the like, or a combination thereof. This state information can be received at the router 120. This information may be contained within an ID tag on each device, a look-up table provided in conjunction with these devices, information provided by the building management system 110, or an external source.

Alternatively, this information can be obtained by an analog method, e.g., a resistance associated with each of these devices. In one embodiment, the state information can be based off of a simulation or 3D model algorithm that anticipates the conditions of the non-light emitting, variable transmission device. This state information can be manually input into a building management system, and the building management system 110 can push this information to the router 120 while the system 100 is being initially configured, reconfigured, or during a system reboot. In one embodiment, an I/O unit can be coupled to the control devices 130, 132, 134, and 136 through the router 120. The I/O unit can provide to a control device signals corresponding to state information that can include a light intensity, an occupancy of a controlled space corresponding to the window, a physical configuration of the controlled space, a temperature, an operating mode of a heating or cooling system, a sun position, color rendering information, a time of day, a calendar day, an elapsed time since a scene has been changed, heat load within the controlled space, a contrast level between relatively bright and relatively dark objects within a field of view where an occupant is normally situated within the controlled space, whether an orb of the sun is in the field of view where the occupant is normally situated within the controlled space, whether a reflection of the sun is in the field of view where the occupant is normally situated within the controlled space, a level of cloudiness, or another suitable parameter, or any combination thereof. The state information may be collected at the I/O unit from sources of state information, such as sensors, a calendar, a clock, a weather forecast, or the like. The controlled space can be an area surrounding a window of the EC device. The controlled spaced may be a room, such as a meeting room or an office, or may be part of a floor of a building. The EC device can then affect light, glare, or temperature of the controlled space.

After receiving the state information, the I/O unit can include logic to categorize and prioritize the state information, at block 406. In one embodiment, the state information can be included into at least two categories. In another embodiment, the state information can be included into at least three categories and no more than twenty categories. For example, the categories can include glare control, daylight transmission, color rendering, and energy saving. The prioritization of the categories can be assigned based on criteria set prior to installation of the non-light-emitting, variable transmission devices.

In an embodiment, the state information may be used to send instructions to control devices 130, 132, 134, and 136. One or more control device may be adjacent to an IGU, and another local control device may be within the controlled space and spaced apart from the IGU. Such other local control device may be near light switches, a thermostat, or a door for the controlled space. Logic operations are described below with respect to particular control devices with respect to an embodiment. In another embodiment, a logic operation described with respect to a particular control device may be performed by another control device or be split between the control devices. After reading this specification, skilled artisans will be able to determine a particular configuration that meets the needs or desires for a particular application.

The system 100 can be used to allow for scene-based control of EC device within a window, such as an IGU installed as part of architectural glass along a wall of a building or a skylight, or within a vehicle. As the number of EC devices for a controlled space increases, the complexity in controlling the EC devices can also increase. Even further complexity can occur when the control of the EC devices is integrated with other building environmental controls. In an embodiment, the window can be skylight that may include over 900 EC devices. Coordinating control of such a large number of EC devices with other environmental controls can lead to very complicated control scenes, which some facilities personnel without extensive computer programming and experience with complex control systems may find very challenging.

The inventors have discovered that using cloud based control of a window can provide a less complicated control methodology that removes the work for facilities based personnel. A scene can be a discrete transmission pattern of the EC devices for the window. In one embodiment, the scene may be a continuous graded transmission. A scene may be selected from a collection of scenes, and the EC devices can be controlled to achieve the scene. The scenes may be validated, so that they are use at appropriate times and under appropriate conditions. The scenes may be correlated to state information, so that a validated scene for the window is used.

A scene generated for a controlled space may have been suitable for an original physical configuration of the controlled space; however, the scene may no longer be acceptable after the physical configuration has changed. For example, the original physical configuration for controlled space may have been a portion of a floor including cubicles room. Remodeling may be performed and additional walls may be installed. The physical configuration of the controlled space may have changed in size and become different controlled spaces, one of which can be a conference room. Glare may be more problematic with the conference room, as compared to the controlled space with cubicles. Thus, a previously validated scene may no longer be acceptable.

When using scene-based control of a window for a controlled spaced, scenes can be part of a collection, and the scene can be selected based on state information received by control devices.

The method 400 can include generating a scene for a window, at block 408. A few exemplary scenes can include all EC devices for a window being at the highest transmission state (fully tinted), all EC devices for the window being at the lowest transmission state (bleached), and different rows of EC devices for the window being at other transmission states. The method can further include determining transmission corresponding to the scene, at block 522. The transmission information may be for each EC device within a scene, so that the scene may be recreated at a later time.

The method can further include validating the scene, at block 524. The validation may depend on the physical configuration of the controlled space, personal preferences, or the like. The window may include three rows of EC devices. For a controlled space with cubicles, the scene illustrated in FIG. 5D may be acceptable, as more light may be needed along a top row to pass over cubicle walls. For a controlled space that is a conference room, a scene, such as the right-most scene in FIG. 5L, may be unacceptable due to too much light entering, particularly later in the morning. However, another scene, such as the scene in FIG. 5B, may be acceptable for a conference room, particularly if the bottom row of EC devices is at or below the level of a table top. The validation may be performed when the building is originally built and configured, and such scenes are referred to herein as original scenes. At a time after generating the original scenes, an occupant or facilities personnel may save a scene that the he or she particularly likes or generates. Such a scene is referred to as a learned scene. For example, after a physical configuration of the controlled space is changed, new scenes may be generated that are more appropriate for the new physical configuration. The local control devices 130, 132, 134, and 136 can include a button that allows the occupant or another human to provide input to the apparatus 200 via the I/O unit to store the scene. Similarly, a prior scene, whether original or learned, may no longer be acceptable in view of the change in physical configuration. The local control devices 130, 132, 134, and 136 may include another button that allows the occupant or another human to provide input to the apparatus 200 via the I/O unit to delete or invalidate the scene. Still further, the local control devices 130, 132, 134, and 136 may allow the occupant to adjust individual EC devices or subsets of EC devices and save the particular scene created. Yet further, when the occupant changes, the learned scenes may be deleted, and the original scenes restored.

The scene selection may be correlated with and based on the prioritization of the state information. The method can include adding the scene to the collection of scenes. On a subsequent day, the control devices 130, 132, 134, and 136 may later select an original or learned scene from the collection of scenes when such scene's corresponding state information matches or is close to state information at the time when the control devices 130, 132, 134, and 136 is being used to select a scene.

After reading this specification, skilled artisans will understand that the order of actions in FIG. 4 may be changed. Furthermore, one or more actions may not be performed, and one or more further actions may be performed in generating the collection of scenes.

After the collection of scenes is generated, a scene from the collection can be selected, and a control device can control the EC devices of the window to achieve scene for the window.

FIGS. 5A-5L includes an exemplary, non-limiting method of operating an apparatus to achieve a scene corresponding to state information and prioritization.

A decision may be performed to determine whether there is a significant change in the state information, at an additional step in method 400. For example, a minute may have passed since state information has been collected, yet, other than the passage of time, nothing of significance may have occurred. During that time, nobody may have entered or left the controlled space, the position of the sun has only insignificantly changed position, the sky may have substantially the same level of clouds between the sun and the controlled space, or the like. In such a situation, the method can proceed on the No branch, and further input corresponding to state information may continued to be received. Alternatively, a significant change may have occurred. For example, a person may have entered the controlled space that was previously unoccupied, a change in sky conditions may have occurred (e.g., a sunny sky may now be cloudy), the sun may no longer be in a position where it directly shines on the window, or the like. When the change is significant, the method can proceed on the “Yes” branch. Thus, the scene for the window may be changed.

Some scenes in that subset may be favored over others in that subset. For example, one of scenes may be a learned scene that is liked by the occupant of the controlled space over other scenes within the subset. Learned scenes may be assigned a higher preference or weighing factor compared to scenes that were generated the time the building was built or before the size and layout for the current physical configuration of the controlled space was made. In another embodiment, a preference or weighing factor may be used for a particular scene that has not been used recently. For example, many scenes may have been used more recently that the particular scene. A higher preference or weighing factor may be used for the particular scene as compared to other scenes, so that the scenes may be rotated and reduce using the same scenes too frequently. The preference or weighing factor is optional and not required in all embodiments. Even though there is no significant change in state information, the scene may be changed to provide a more visible perception that the day is progressing. For example, the scene may be changed at least once for predetermined amount of time, such as 5 minutes, 10 minutes, 20 minutes, or the like. The control device can select a new scene from the subset of scenes and change the voltages of the EC devices to achieve the new scene.

At a later time, the control of the EC devices may be terminated. Thus, a decision can be made whether to terminate control. For example, each day after sunset, the EC devices may be changed to the highest transmission state and no longer controlled until just before sunrise the next day. In this particular embodiment, the control can be terminated, corresponding to the “Yes” branch. Otherwise, the method proceeds along the “No” branch.

The scene-based selection may be better understood with particular examples that are described with respect to FIGS. 5A to 5L. FIGS. 5A to 5L include an illustration of a window that includes many IGUs each having an EC device. In the examples described, the EC devices will be in one of three states to simplify understanding of the concepts as described herein. The states include a high transmission state, a low transmission state, and an graded transmission state that is between the high transmission state and the low transmission state. The high transmission state may be at the highest level of transmission (fully bleach), the low transmission state may be at the lowest level of transmission (fully tinted) and the graded transmission state may be in between the highest transmission state and lowest transmission state. In actual practice, a continuum of transmission states can be used. After reading this specification, skilled artisans will be able to determine transmission states that will be used with the scenes. In one embodiment, the IGU may be at the highest transmission state, as in FIG. 5A. In another embodiment, the IGU may be at the lowest transmission state, as in FIG. 51. In yet another embodiment, the IGU can have an EC device in the highest transmission state adjacent to a second EC device with an intermediate transmission state, as seen in FIG. 5B, FIG. 5C, FIG. 5J, FIG. 5E, and FIG. 5K. After the prioritization, each individual EC device can be controlled remotely to generate a specific scene.

Embodiments as described above can provide benefits over other systems with non-light-emitting, variable transmission devices. The use of remote scene selection and control can help with maintenance of an installed device. The methods as described herein allow all non-light-emitting, variable transmission devices coupled to be controlled individually based on the state information received and prioritization of that state information.

Many different aspects and embodiments are possible. Some of those aspects and embodiments are described below. After reading this specification, skilled artisans will appreciate that those aspects and embodiments are only illustrative and do not limit the scope of the present invention. Exemplary embodiments may be in accordance with any one or more of the ones as listed below.

Embodiment 1. A system that includes a control device configured to select a first scene from a collection of scenes for a window including switchable devices in response to receiving a first input corresponding to prioritized state information, and a remote management system configured to send the prioritized state information.

Embodiment 2. A system that includes a first non-light-emitting, variable transmission device, a first controller coupled and configured to select a first scene from a collection of scenes for a window including the non-light emitting, variable transmission device, and a management system that includes a logic element configured to: receive state information, prioritize the received state information, and send signals to the first controller in response to input corresponding to prioritized state information.

Embodiment 3. A method of controlling a non-light emitting, variable transmission device that includes receiving state information from at least one non-light-emitting, variable transmission device, wherein the at least one non-light-emitting, variable transmission device has a first transmission level, prioritizing the received state information, sending signals from a remote management system to a first controller in response to input corresponding to prioritized state information, and changing the first transmission level of the at least one non-light-emitting, variable transmission device to a second transmission level for the at least one non-light-emitting, variable transmission device in response to the signals received from the remote management system.

Embodiment 4. The method or system of any one of embodiments 1 to 3, where the remote management system is a wireless system.

Embodiment 5. The method or system of any one of embodiments 1 to 3, where the prioritized state information includes a light intensity, a physical configuration of a controlled space, a sun position, a time of day, a calendar day, or a level of cloudiness.

Embodiment 6. The method or system of any one of embodiments 1 to 3, where the prioritized state information includes a contrast level between relatively bright and relatively dark objects within a field of view where an occupant is normally situated within a controlled space, whether an orb of the sun is in the field of view where the occupant is normally situated within the controlled space, whether a reflection of the sun is in the field of view where the occupant is normally situated within the controlled space, or an elapsed time since a scene has been changed.

Embodiment 7. The method or system of any one of embodiments 1 to 3, where the prioritized state information an occupancy of a controlled space corresponding to the window, a temperature, heat load within the controlled space, or an operating mode of a heating or cooling system.

Embodiment 8. The method or system of any one of embodiments 1 to 3, where the prioritized state information includes information from a 3D simulation model of the non-light-emitting, variable transmission device.

Embodiment 9. The method or system of any one of embodiments 1 to 3, where the collection of scenes includes a set of discrete transmission patterns for the window, where the discrete transmission patterns correspond to the scenes.

Embodiment 10. The system of any one of embodiments 1 or 2, further comprising the window including the switchable devices coupled to the control device, wherein the switchable devices affect transmission of light through the window.

Embodiment 11. The system of embodiment 1, further comprising at least one non-light-emitting, variable transmission device, where the non-light-emitting, variable transmission device comprise a first electrochromic device having a first edge, a second electrochromic device having a second edge, and a third electrochromic device having a third edge and a fourth edge, the first edge of the first electrochromic device is immediately adjacent to the third edge of the third electrochromic device, and the second edge of the second electrochromic device is immediately adjacent to the fourth edge of the third electrochromic device, and for the first scene, where comparing transmission levels of the first, second, and third electrochromic devices, the first electrochromic device has a lowest transmission level, the second electrochromic device has a graded transmission level, and the third electrochromic device has a highest transmission level.

Embodiment 12. The method or system of any one of embodiments 1 to 3, further including at least one non-light-emitting, variable transmission device, where at least one non-light-emitting, variable transmission device has a graded transmission level.

Embodiment 13. The method or system of any one of embodiments 1 to 3, where a collection of scenes, including the first scene, includes a set of discrete transmission patterns for the window.

Embodiment 14. The method of embodiment 13, where the collection include a first pre-programmed scene and a first learned scene, wherein the first scene is the first pre-programmed scene or the first learned scene.

Embodiment 15. The method of embodiment 14, further including adding a first learned scene to the collection of scenes.

Embodiment 16. The method of embodiment 15, further including deleting the first learned scene from the collection of scenes.

Embodiment 17. The method of embodiment 16, further including changing a physical configuration within the controlled space.

Embodiment 18. The method of embodiment 17, further including adding a second learned scene to the collection of scenes, wherein the second learned scene is different from the first learned scene.

Embodiment 19. The method of embodiment 18, where adding the second learned scene is performed after changing the physical configuration within a controlled space and deleting the first learned scene.

Embodiment 20. The method or system of any one of embodiments 1 to 3, where the second transmission level is different from the first transmission level.

Note that not all of the activities described above in the general description or the examples are required, that a portion of a specific activity may not be required, and that one or more further activities may be performed in addition to those described. Still further, the order in which activities are listed is not necessarily the order in which they are performed.

Certain features that are, for clarity, described herein in the context of separate embodiments, may also be provided in combination in a single embodiment. Conversely, various features that are, for brevity, described in the context of a single embodiment, may also be provided separately or in any subcombination. Further, reference to values stated in ranges includes each and every value within that range.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims.

The specification and illustrations of the embodiments described herein are intended to provide a general understanding of the structure of the various embodiments. The specification and illustrations are not intended to serve as an exhaustive and comprehensive description of all of the elements and features of apparatus and systems that use the structures or methods described herein. Separate embodiments may also be provided in combination in a single embodiment, and conversely, various features that are, for brevity, described in the context of a single embodiment, may also be provided separately or in any subcombination. Further, reference to values stated in ranges includes each and every value within that range. Many other embodiments may be apparent to skilled artisans only after reading this specification. Other embodiments may be used and derived from the disclosure, such that a structural substitution, logical substitution, or another change may be made without departing from the scope of the disclosure. Accordingly, the disclosure is to be regarded as illustrative rather than restrictive.

What is claimed is:

1. A system, comprising:
a control device configured to select a first scene from a collection of scenes for a window including switchable devices in response to receiving a first input corresponding to prioritized state information; and
a remote management system configured to send the prioritized state information.

2. The system of claim 1, further comprising at least one non-light-emitting, variable transmission device, wherein:
the non-light-emitting, variable transmission device comprise a first electrochromic device having a first edge, a second electrochromic device having a second edge, and a third electrochromic device having a third edge and a fourth edge;
the first edge of the first electrochromic device is immediately adjacent to the third edge of the third electrochromic device, and the second edge of the second electrochromic device is immediately adjacent to the fourth edge of the third electrochromic device; and
for the first scene, where comparing transmission levels of the first, second, and third electrochromic devices, the first electrochromic device has a lowest transmission level, the second electrochromic device has a graded transmission level, and the third electrochromic device has a highest transmission level.

3. The system of claim 1, wherein the collection of scenes comprises a set of discrete transmission patterns for the window, wherein the set of discrete transmission patterns correspond to the scenes.

4. The system of claim 1, wherein the first scene comprises a set of discrete transmission pattern for the window.

5. The system of claim 1, wherein the collection of scenes comprises a first pre-programmed scene and a first learned scene, wherein the first scene is the first pre-programmed scene or the first learned scene.

6. The system of claim 5, further comprising adding a second learned scene to the collection of scenes.

7. The system of claim 5, further comprising deleting the first learned scene from the collection of scenes.

8. The system of claim 1, further comprising changing a physical configuration within the controlled space.

9. The system of claim 8, further comprising adding a second learned scene to the collection of scenes, wherein the second learned scene is different from the first learned scene.

10. The system of claim 9, wherein adding the second learned scene is performed after changing the physical configuration within a controlled space and deleting the first learned scene.

11. A system, comprising:
a first non-light-emitting, variable transmission device;
a first controller coupled and configured to select a first scene from a collection of scenes for a window including the non-light emitting, variable transmission device; and
a management system that includes a logic element configured to:
receive state information;
prioritize the received state information; and
send signals to the first controller in response to input corresponding to prioritized state information.

12. The system of claim 11, further comprising the window including the switchable devices coupled to the control device, wherein the switchable devices affect transmission of light through the window.

13. The system of claim 11, further comprising at least one non-light-emitting, variable transmission device, wherein at least one non-light-emitting, variable transmission device has a graded transmission level.

14. The system of claim 11, wherein the second transmission level is different from the first transmission level.

15. A method of controlling a non-light emitting, variable transmission device, comprising:
receiving state information from at least one non-light-emitting, variable transmission device, wherein the at least one non-light-emitting, variable transmission device has a first transmission level;
prioritizing the received state information; and
sending signals from a remote management system to a first controller in response to input corresponding to prioritized state information;
changing the first transmission level of the at least one non-light-emitting, variable transmission device to a second transmission level for the at least one non-light-emitting, variable transmission device in response to the signals received from the remote management system.

16. The method of claim 15, wherein the remote management system is a wireless system.

17. The method of claim 15, wherein the prioritized state information comprises a light intensity, a physical configuration of a controlled space, a sun position, a time of day, a calendar day, or a level of cloudiness.

18. The method of claim 15, wherein the prioritized state information comprises a contrast level between relatively bright and relatively dark objects within a field of view where an occupant is normally situated within a controlled space, whether an orb of the sun is in the field of view where the occupant is normally situated within the controlled space, whether a reflection of the sun is in the field of view where the occupant is normally situated within the controlled space, or an elapsed time since a scene has been changed.

19. The method of claim 15, wherein the prioritized state information comprises an occupancy of a controlled space corresponding to the window, a temperature, heat load within the controlled space, or an operating mode of a heating or cooling system.

20. The method of claim 15, wherein the prioritized state information comprises information from a 3D simulation model of the non-light-emitting, variable transmission device.
